(19) United States
(12) Patent Application Publication
(10) Pub. No.: US 2003/0050725 A1
(43) Pub. Date: Mar. 13, 2003

(54) Method for reliable high-performance recording of process data with numerically controlled industrial processing machines

(75) Inventor: Rainer Dirnfeldner, Herzogenaurach (DE)

Correspondence Address: Henry M. Feiereisen, Suite 3220, 350 Fifth Avenue, New York, NY, 10118, US

(73) Assignee: SIEMENS AKTIENGESELLSCHAFT, Munchen (DE)

(21) Appl. No.: 10/241,811

(22) Filed: Sep. 11, 2002

(30) Foreign Application Priority Data
Sep. 11, 2001 (DE) 101 44 788.4

(51) Int. Cl. G06F 19/00

(52) U.S. Cl. 700/174; 700/177

(57) ABSTRACT

Process data are recorded by accumulating process data in a delay-time critical cyclic time plane—e.g., a main processor clock—and storing the accumulated data in an data buffer memory having a FIFO characteristic using a cyclic clock. The data buffer memory is read out in a delay-time uncritical acyclic time plane—e.g., a pre-process clock—and the read out data are processed and stored as data sets in a log memory. To achieve synchronous recording of process data of different time planes, such as process data generated in a cyclic interpolator time plane and a cyclic position control time plane, the process data for position control are accumulated over the time interval of an interpolation clock cycle and provided synchronously with the data of the interpolator for recording.

### CROSS-REFERENCES TO RELATED APPLICATIONS

This application claims the priority of German Patent Application Serial No. 101 44 788.4, filed Sep. 11, 2001, pursuant to 35 U.S.C. 119(a)-(d), the subject matter of which is incorporated herein by reference.

### BACKGROUND OF THE INVENTION

The present invention relates to a method for reliable, high-performance recording of process data with numerically controlled industrial processing machines, such as machine tools and robots, as well as a corresponding device, in particular a numeric controller.

Heretofore, there is a lack of methods to allow collection of data of different time planes on a CNC without data loss and to provide external components for further processing in near real time. Instead, conventional methods implement for each intended application a separate data recording which is specifically tailored to the application's requirements, as listed in the following examples.

For graphic simulation, a number of data are recorded which are collected at the time when the software for the CNC is developed. Only data of the so-called interpolator time plane are taken into consideration. Details of a numeric control for machine tools using an interpolator are given, for example, in EP 0 513 417 B1 wherein points located between defined path points of a trajectory are clocked at an interpolation cycle which is longer than a position controller cycle and defines the interpolator time plane. The patent reference EP 0 513 417 B1 is incorporated herein by reference in its entirety.

In a so-called oscilloscope function, only data for a servo control are initially recorded. The storage capacity of the CNC is typically limited to only this function, which severely restricts the maximum possible recording duration. Graphic processing is then done off-line subsequent to the recording.

Moreover, external components (for example, an operator interface and/or a man-machine-interface MMI) cyclically read the process data, which makes it almost impossible to recognize rapid changes. Such method is only suitable for display on a display screen (e.g., current values), but not for additional processing.

These individual solutions result in significant development and maintenance expenses. Typically, a suitable recording method has to be developed for each new application. This may be possible only in a limited fashion if the application is implemented by an OEM (third-party manufacturer) or by an external software house as an add-on.

It would therefore be desirable and advantageous to enable a uniform recording of process data of numerically controlled industrial processing machines (CNC), which can be used for a graphically simulating the process flow of the machine synchronous with the machining operation; providing an oscilloscope function (graphic representation of temporal correlation between several process data) for easy startup of the machine; monitoring the process data to enhance the safety of personnel, machine and workpiece (e.g., monitoring breakage of the workpiece for rapidly lifting the tool from the workpiece); transmitting process data via a network (e.g. Internet) for remote diagnosis by the manufacturer of the machine or the controller; and facilitating addition of OEM applications to solve technical problems, e.g., by a manufacturer of the machine.

It would further be desirable and advantageous to enable recording of process data during operation of numerically controlled industrial processing machines, which can satisfy the aforedescribed requirements and obviates the disadvantages of conventional individual solutions.

### SUMMARY OF THE INVENTION

According to one aspect of the invention, a method for reliable high-performance recording of process data with numerically controlled industrial processing machines, such as machine tools or robots, includes collecting process data in a delay-time critical cyclical time plane and storing the process data in cyclical intervals in an data buffer memory having a first-in-first-out characteristic (FIFO; OEM-FIFO), adding the buffer memory in a delay-time non-critical acyclic time plane, and processing and storing the read out data are as data sets in a log memory (FIFO-FILE).

Embodiments of the invention can have one or more of the following features. The log memory can have a First-In-First-Out characteristic, and the data buffer memory (FIFO) and the log memory (FIFO-FILE) can be formed as a ring buffer. For synchronous recording of process data in different time planes, the process data can be generated in a cyclic interpolator time plane (IPO) and a cyclic position control time plane (SERVO), and process data associated with the position control can be collected over a time of an interpolation clock cycle and provided for recording synchronously with the collected process data.

Deleting the data sets read from the log memory ensures that there is always sufficient storage capacity for new entries. Advantageously, a list with data is provided that parametrizes which incoming process events to be recorded. Additional advantageous functionality can be achieved by providing data read from the data buffer memory with header information when they are processed into data sets. Packets lost due to missing numbers can be identified from the header information since consecutive data sets are numbered sequentially. Advantageously, by using the header information, a data set can be associated with an event that initiated the recording.

Advantageously, at the start of a recording, a parameter can be set that defines a specified process event and a corresponding threshold value, and the recording can be automatically terminated when the threshold value is exceeded and/or underrun. Alternatively, when the threshold value is exceeded and/or underrun, the recording can be terminated with a delay that corresponds to a predeterminable number of process events. This guarantees, for example in the event of a tool breakage, that the critical operating status is recorded. In addition, a recording of process data can be initiated and/or terminated by a parts program using a suitable programming command.

According to another aspect of the invention, a device—in particular in form of a programmable numeric controller—is provided that is capable of carrying out the aforedescribed method steps of the invention.

According to yet another aspect of the invention, a computer program product running on a digital computer is provided, wherein the program product can be loaded directly into the internal memory of the digital computer and comprises software sections for carrying out the aforedescribed method steps of the invention.

According to still another aspect of the invention, a numeric controller for reliable high-performance recording of process data, includes a data buffer memory having a first-in-first-out characteristic (FIFO; OEM-FIFO) for storing process data collected in a delay-time critical cyclical time plane of the numeric controller; and a master log memory (FIFO-FILE) for storing data read out from the buffer memory in a delay-time non-critical acyclic time plane and processed as data sets.

The proposed solution implements a recording method which can achieve at least one of the following advantages:

general, open access data interface also for parameterization,

flexible initiation of data recording,

unrestricted selection of the data to be recorded (date, initiating event, format),

identification marks for lost data sets,

trigger possibility for controlling the recording duration,

synchronization of servo data with interpolator and/or IPO data (servo→IPO interface),

decoupling of the recording in the IPO from the data output,

log file with FIFO characteristic (data administration→communication interface), and

continuous transmission chain from servo to MMI.

The aforedescribed logging functionality according to the invention enables a high-performance synchronous recording of data in the time plane of an interpolator (interpolation timing signal). In this way, different functions can be implemented on a numeric controller, for example a graphic simulation of the machining synchronous with the machining operation itself, monitoring tool breakage or a diagnosis of synchronous events.

The recording is hereby done in relation to specified process events and the system (e.g., IPO timing, set change, start/stop of axial movement, tool change, etc.). A list of data to be recorded can be predefined for each event. Preferably, all values/parameters that are defined in an operator console interface BTSS are available.

The recorded data are preferably stored in a file in a passive file system of the controller (in the form of a so-called log file PF). These data can be uploaded simultaneously for logging to a passive file system of the controller, so that the limited memory of the controller kernel (NCK) does not limit the amount of logged data.

The logging function is preferably parameterized via the operator console interface BTSS. The logging function can be adapted for multi-user operation, i.e., through parallel access for different applications.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a schematic block diagram of an internal configuration of a log file according to the invention; and

FIG. 2 shows a schematic diagram of a FIFO buffer memory as a ring buffer.

### DETAILED DESCRIPTION OF PREFERRED EMBODIMENTS

Certain useful background information will now be provided before discussing the actual technical implementation.

The entire parameterization of data recording (specifying the format and the events for recording the data) is implemented via a general open-access data interface BTSS. Access to the BTSS is enabled for parts programs, NCK-OEM compile cycles and, with the help of a variable service, also for external components (MMI). This open accessibility allows the manufacturer of the controller, the manufacturer of the machine, the OEM developer and also the end-user to make use of the recorded data.

Various system events can initiate data recording (for example, NC start/stop, beginning/end of a set, tool change, start/stop of axial movement, IPO timing pulse). In addition to the system events, arbitrary OEM events can also be defined by NCK-OEM compile cycles. In addition, data recordings can also be initiated by parts programs.

Data to be recorded (date, initiating event, format) can be flexibly selected. Each of these events can be set to indicate if data are to be recorded or not. A list of arbitrary process data can be assembled for those events that are to be recorded. In addition, the form of the recording (e.g., format, environment) can also be selected.

Each recorded data set includes a header aiding in the identification of lost data sets. In addition, the header can also associate the data set with the event that initiated the recording.

At the start of the recording, a BTSS variable can be selected whose values will subsequently be monitored. If the value underruns or exceeds a certain threshold value, then a trigger is activated and the recording is automatically stopped. This allows logging of critical operating states.

The servo process data are accumulated during an IPO timing pulse and made accessible to the BTSS. In this way, the process data of the IPO and the process data of the servo are synchronized for recording the data in the IPO.

Recording in the IPO is decoupled from the data storage. The data are recorded in the time plane of the IPO initially in a data format which is optimized for delay-time. The data are stored in a data region having First-In-First-Out (FIFO) characteristic. The FIFO is read out in the delay-time uncritical acyclic time plane, the data are processed (e.g., format conversion) and stored in a so-called log file PF in the file system (e.g., SRAM)

The log file has typical file characteristics, i.e., it can be, for example, copied, deleted, edited or read by a domain upload process. In addition, the log file operates during the domain upload like a FIFO, wherein read data sets are deleted from the log file, thereby creating space for new entries. The data can also be communicated to external components in near real time. The existing memory configuration of the CNC does not limit data recording as a result of external safeguarding and/or additional processing of the data.

Process data can be recorded and read out synchronously in near real time with the aforedescribed three intermediate data memories which function as buffers between the individual time planes of the CNC software. Buffers with sufficient capacity ensure that no data are lost. Each time plane only performs those tasks that are absolutely necessary in that specific time plane and delegates the other tasks to the next lower time plane. In this way, the manufacturing process is typically not significantly affected by the data recording process.

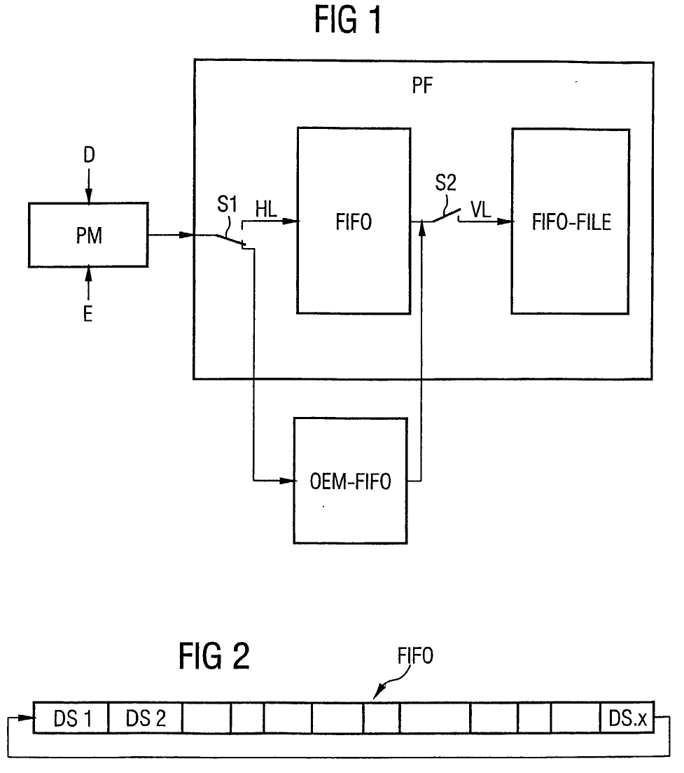

The diagram of FIG. 1 shows the internal configuration of a log file PF according to the invention. The data to be logged are entered into a so-called log file. In the present embodiments, this is a specific file type of the passive file system. As a new file type, the log file includes as an essential characteristic a fast FIFO buffer memory FIFO. This buffer memory FIFO is operated from the main process HL (switch S1 controls synchronously with the clock of HL). Data D which are provided by a protocol manager PM in response to defined events E are imported in the buffer memory FIFO synchronously with the main process HL.

The data of the buffer memory FIFO are then imported (uploaded) from the buffer memory into the actual log memory FIFO-FILE in the time plane of the pre-process VL (switch S2). Only the FIFO-FILE is visible to and accessible from the outside as the actual log file PF (for example, for reading and processing the accumulated log data).

As discussed below, an OEM-FIFO having the same functionality can be connected in parallel to the buffer memory FIFO to enable possible upgrades by OEM manufacturers which can then take advantage of the features of the log file.

FIG. 2 shows a configuration of the two FIFO intermediate memories FIFO and OEM-FIFO implemented as a ring buffer with exemplary data sets Ds1, Ds2, . . . , Ds.x. In this way, data that have been read out can essentially be deleted and/or their memory locations can be made available by setting a pointer to the next free memory location within the ring buffer.

The NCK-compile cycle can block and release a transmission of data form a FIFO buffer memory to the FIFO file.

The comparatively fast FIFO buffer memory FIFO accepts the logged data with the IPO clock until the data can be transferred in the time plane of the pre-process to the log file. If several process events are active and/or parameters are to be set for several data values, then the buffer memory can overflow (for example, overflow of the ring buffer when more data are entered into the main process than can be read out by the pre-process), causing data loss. The capacity of the buffer memory FIFO is selected to be sufficiently large for the existing applications. For OEM applications, however, where large quantities of data have to be recorded (e.g., for tool overload monitoring), the standard size of the buffer memory may not be sufficient.

It may also be possible to save the actual log files FIFO-FILE during the logging process in the time plane of the pre-process VL. In this way, operating states of interest (for example, overload conditions) can be retained for graphic processing. This safety feature, unlike the original file, operates like a “normal” file (no FIFO characteristic and no upload characteristic with deletion). The logging operation continues in parallel without interruption.

Data of events to be logged can belong to the time plane of the interpolator IPO, whereas other data can belong to the time plane of the pre-process. It should be noted that a user is permitted to simultaneously activate only events belonging to the same time plane. A list of data to be logged can be defined for each event.

In certain applications, the logging process has to record data over long time periods, while these data may be relevant only for a short time (for example, to monitor tool breakage). In this case, the operator initially does not read the data from the log file PF, so that the data are recorded in the log memory FIFO-FILE according to the FIFO protocol. When the file is full, the oldest recordings are purged and replaced with the newer recordings.

However, it should be possible to timely stop data logging, so that the relevant data are retained in the log file PF. For this purpose, the following enhanced functionality is provided.

Each user can determine a process event whose value is monitored during each logging operation. This value is compared as before with a threshold value. A positive result of the comparison indicates that the logging process should be stopped automatically. However, the process need not be stopped immediately, but can be stopped after a delay of a predetermined number of events (delay).

Assuming that the events are distributed predictably and uniformly over time (which is typically the case for events occurring synchronously with the interpolation clock), then a number of events can be set equal to a time duration. The specified capacity of the log memory FIFO-FILE accepts a certain number of events and can therefore be viewed as a time window. The delay moves this time window.

If the delay is very long in relation to the log file, then the trigger may fall outside the time window. A simple example is described below to illustrate the logic behind this:

The x-value and y-value are to be recorded synchronously with the interpolation clock. The log file has capacity of, for example, 6 data sets and/or interpolation clock cycles. The trigger signal should be sent when the y-value exceeds a value of 50. 3 additional data sets should be recorded after the trigger signal.

Logging of server data will now be described in detail. The logging of servo data has certain particularities from the system's perspective, since the data exist in a time plane (servo) different from the time plane in which they were recorded (interpolation or IPO).

From the perspective of the user, the servo data are typically part of the operator console interface BTSS and are therefore treated the same as all other data to be logged.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

What is claimed is:

1. A method for reliable high-performance recording of process data with numerically controlled industrial processing machines, such as machine tools or robots, comprising the steps of:
collecting process data in a delay-time critical cyclical time plane;
storing the process data in cyclical intervals in a data buffer memory having a first-in-first-out characteristic (FIFO; OEM-FIFO),
reading the data buffer memory in a delay-time non-critical acyclic time plane, and
processing and storing the read out data as data sets in a log memory (FIFO-FILE).

2. The method of claim 1, wherein the log memory also has a First-In-First-Out (FIFO) characteristic.

3. The method of claim 1, wherein the data buffer memory (FIFO) and the log memory (FIFO-FILE) are formed as a ring buffer.

4. The method of claim 1, wherein the process data are generated in a cyclic interpolator time plane (IPO) and a cyclic position control time plane (SERVO) and the process data associated with the position control are collected over a time of an interpolation clock cycle and provided for recording synchronously with the collected process data.

5. The method of claim 1, wherein the data sets are always deleted in the data buffer memory after having been read from the data buffer memory.

6. The method of claim 1, and further comprising the step of providing a list with data that define parameters of those process events that are to be stored in the log memory.

7. The method of claim 1, and further comprising the step of providing the data read from the data buffer memory with a header information before being processed into data sets.

8. The method of claim 7, wherein the header information includes sequential numbering of consecutive data sets.

9. The method of claim 7, wherein the header information associates a data set with an event that initiated storing of the process data in the log memory.

10. The method of claim 1, and further comprising the steps of setting a parameter that defines a specified process event and a corresponding threshold value before recording the process data, comparing the process data with the threshold value, and automatically terminating recording the process data when the process data exceed or underrun the threshold value.

11. The method of claim 10, wherein the recording is terminated with a delay corresponding to a predeterminable number of process events when the process data exceed or underrun the threshold value.

12. The method of claim 1, and further comprising the step having a parts program provide a programming command to one of initiate and terminate recording of the process data.

13. A device for reliable high-performance recording of process data with numerically controlled industrial processing machines, such as machine tools or robots, comprising:
a protocol manager collecting process data in a delay-time critical cyclical time plane;
a data buffer memory having a first-in-first-out characteristic (FIFO; OEM-FIFO) for storing the process data in cyclical intervals, and
a log memory (FIFO-FILE) that reads the data buffer memory in a delay-time non-critical acyclic time plane, and processes and stores the read out data as data sets.

14. The device of claim 13, implemented as a programmable numeric controller.

15. A computer program product executed on a digital computer, the computer program product including computer instructions for causing the digital computer to collect process data in a delay-time critical cyclical time plane;
store the process data in cyclical intervals in a data buffer memory having a first-in-first-out characteristic (FIFO; OEM-FIFO), read the data buffer memory in a delay-time non-critical acyclic time plane, and process and store the read out data as data sets in a log memory (FIFO-FILE).

16. A numeric controller for reliable high-performance recording of process data, comprising.
a data buffer memory having a first-in-first-out characteristic (FIFO; OEM-FIFO) for storing process data collected in a delay-time critical cyclical time plane of the numeric controller; and
a log memory (FIFO-FILE) for storing data read out from the buffer memory in a delay-time non-critical acyclic time plane and processed as data sets.

17. The numeric controller of claim 16, wherein the log memory has a First-In-First-Out (FIFO) characteristic.

18. The numeric controller of claim 16, wherein the data buffer memory (FIFO) and the log memory (FIFO-FILE) are formed as a ring buffer.
